(19) United States
(12) Patent Application Publication
(10) Pub. No.: US 2012/0145522 A1
(43) Pub. Date: Jun. 14, 2012

(54) ILLUMINATING KEY CAP STRUCTURE AND METHOD FOR MAKING THE SAME

(76) Inventor: Chih-Lun Lee, Taoyuan (TW)

(21) Appl. No.: 13/013,824

(22) Filed: Jan. 26, 2011

(30) Foreign Application Priority Data
Dec. 10, 2010 (TW) 099143264
Dec. 10, 2010 (TW) 099224023

(51) Int. Cl. H01H 3/12; B29C 69/00

(52) U.S. Cl. 200/312; 264/132

(57) ABSTRACT

A illuminating key cap structure includes a case filling layer including a filling material, a back color layer covering the top surface of the case filling layer, a symbol layer covering the back color layer, an illuminating layer including an illuminating material, covering the back color layer and in direct contact with the symbol layer and a translucent passivation layer covering the top surface of the case filling layer.

### BACKGROUND OF THE INVENTION

1. Field of the Invention

The present invention generally relates to an illuminating key cap structure. In particular, the present invention is directed to an illuminating keycap structure with an illuminating material. The illuminating layer and the symbol layer in the present invention may have an optional sequence

2. Description of the Prior Art

As technology advances, people have access to all kinds of electronic devices such as computers, lap tops, or mobile phones. All these devices require an input device such as a keyboard or a mouse for operation.

In recent years, users are likely to use these electronic devices in many different situations due to their portability. Taking the mobile phone as an example, when a user desires to use this device in different environments, the symbols on the display may be so vague that users will not be able to operate the phone efficiently, particularly if the users are in a darker place where there is insufficient light.

This is even true for users who use computers. When users are in a darker place, insufficient light will cause users to make many mistakes. If the computer comprises an illuminated keyboard, this will aid the user greatly.

A keyboard with key caps which are able to illuminate is known, allowing users to use the keyboard in dark conditions. In such a keyboard, multiple illuminating elements are disposed on a circuit and the circuit is disposed on one side of the keyboard. The light coming from the illuminating elements is guided to the bottom of the key caps by a guiding film that illuminates all the key caps.

The light source for use in the back light module may be a cold cathode fluorescent lamp (CCFL), a hot cathode fluorescent lamp (HCFL), electro luminescence (EL) or a light emitting diode (LED). Some of the known keyboards use EL or LED as the light source. Some others use fluorescent tags as the light source. Such fluorescent tags may come off from the keyboards or be lost, so they are not an ideal solution.

Given the above, a novel key caps and keyboard with self-illuminating properties is still needed to solve the above problems. This will enable users to still see the symbols on a keyboard in a place with insufficient light.

### SUMMARY OF THE INVENTION

The present invention first proposes an illuminating key cap structure. The illuminating key cap structure includes a filling layer, a back color layer, a symbol layer, an illuminating layer, and a protection layer. The filling layer includes a filling material. The back color layer covers the top surface of the filling layer. The symbol layer covers the back color layer. The illuminating layer includes an illuminating material and covers the back color layer. The illuminating layer is in direct contact with the symbol layer. The protection layer which is translucent covers the top surface of the filling layer.

In a first embodiment of the present invention, the filling layer may include a polymer, such as a hard plastic or a soft silicone. In a second embodiment of the present invention, the back color layer has a light color to serve as a contrast basis for the symbol layer. In a third embodiment of the present invention, the illuminating layer directly covers the symbol layer, or the symbol layer directly covers the illuminating layer. In a fourth embodiment of the present invention, the symbol layer includes at least one color, such as red, yellow, green, blue or black. In a fifth embodiment of the present invention, the illuminating layer includes at least one of a sulfide, an alumina, a rare earth element, a fluorescent material and a phosphorescent material, such as ZnS, CaS, SrAl₂O₄, CaAl₂O₄ and BaAl₂O₄. In a sixth embodiment of the present invention, the illuminating material has a thickness of 50 μm-100 μm. In a seventh embodiment of the present invention, the protection layer may include a transparent polymer, such as a polycarbonate film and/or a polyethylene glycol film. In an eighth embodiment of the present invention, the protection layer may have a thickness of 1 mm-0.8 mm.

The present invention also proposes a method for making key caps. First, a translucent protection layer is provided. Second, an illuminating layer is printed on the protection layer. Then, a symbol layer is printed on the protection layer. Next, a back color layer is printed on the protection layer with the illuminating layer and the symbol layer thereon. Later, the protection layer with the illuminating layer, the symbol layer and the back color layer is processed to become a shell-like film. Afterwards, a filling layer is formed on the back color layer to form multiple connecting key caps.

In a first embodiment of the present invention, an optional baking step may be carried out after each step. In a second embodiment of the present invention, the illuminating layer printing step is performed after the symbol layer printing step. In a third embodiment of the present invention, the illuminating layer printing step is performed before the symbol layer printing step. In a fourth embodiment of the present invention, a surface color layer printing step is carried out to print a surface color layer on the protection layer. In a fifth embodiment of the present invention, the illuminating layer includes at least one of a sulfide, an alumina, a rare earth element, a fluorescent material and a phosphorescent material. In a sixth embodiment of the present invention, the illuminating layer may include ZnS, CaS, SrAl₂O₄, CaAl₂O₄ and BaAl₂O₄. In a seventh embodiment of the present invention, a die cutting step may be carried out to cut the shell film including the filling layer to form a plurality of independent key caps because the product has multiple connecting key caps. In an eighth embodiment of the present invention, the die cutting step uses a cutting mold. In a ninth embodiment of the present invention, the die cutting step uses a laser.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 to 7A illustrate the method for making key caps and keyboards of the present invention.

FIG. 8 illustrates a flow chart of the method for making key caps and keyboards of the present invention.

FIG. 9 illustrates another flow chart of the method for making key caps and keyboards of the present invention.

FIGS. 10-14 illustrate various embodiments of the illuminating key cap structure of the present invention.

### DETAILED DESCRIPTION

The present invention provides a method for making key caps and keyboards with self-illuminating properties. The illuminating layer printing step and the symbol layer printing step in the present invention may have an optional order. The obtained key caps and keyboards may provide the users with better convenience, namely, the users are still able to see the symbols on the keyboards in a place with insufficient light.

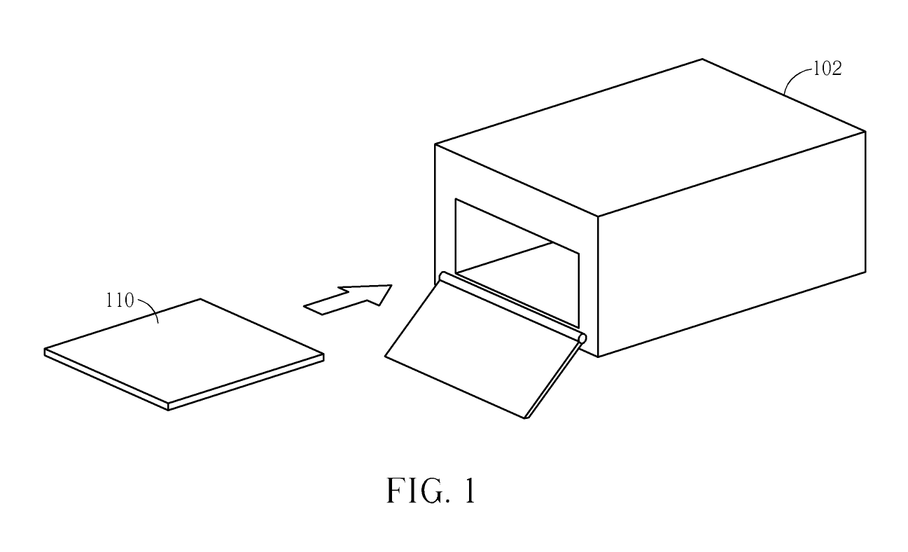

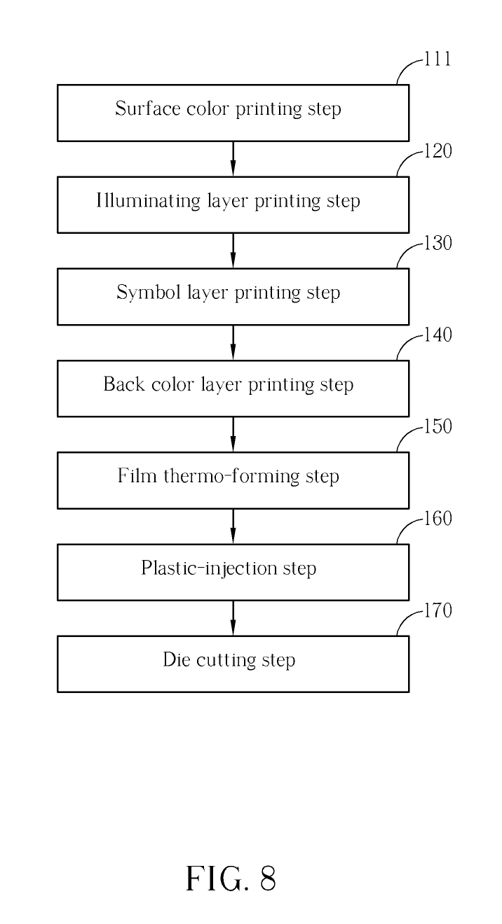

Please refer to FIGS. 1 to 7A, which illustrate the method for making key caps and keyboards of the present invention. First, please refer to FIGS. 1 and 8, which illustrate a protection layer 110 which is transparent or translucent is provided. The protection layer 110 is for use in protecting other elements in the key caps from damage, such as dust, vapor, or scratches. The protection layer 110 also has to make the underlying symbols visible to the users. The protection layer 110 usually includes a polymer material, such as at least one of a polycarbonate film and a polyethylene glycol film. For example, the protection layer 110 may have a thickness between 1 mm-0.8 mm.

Optionally, a surface color layer printing step 111 may be carried out: for example, a surface color layer 112 is printed on the protection layer 110, such as by screen printing, then they are baked in a baking device 102, as shown in FIG. 1A.

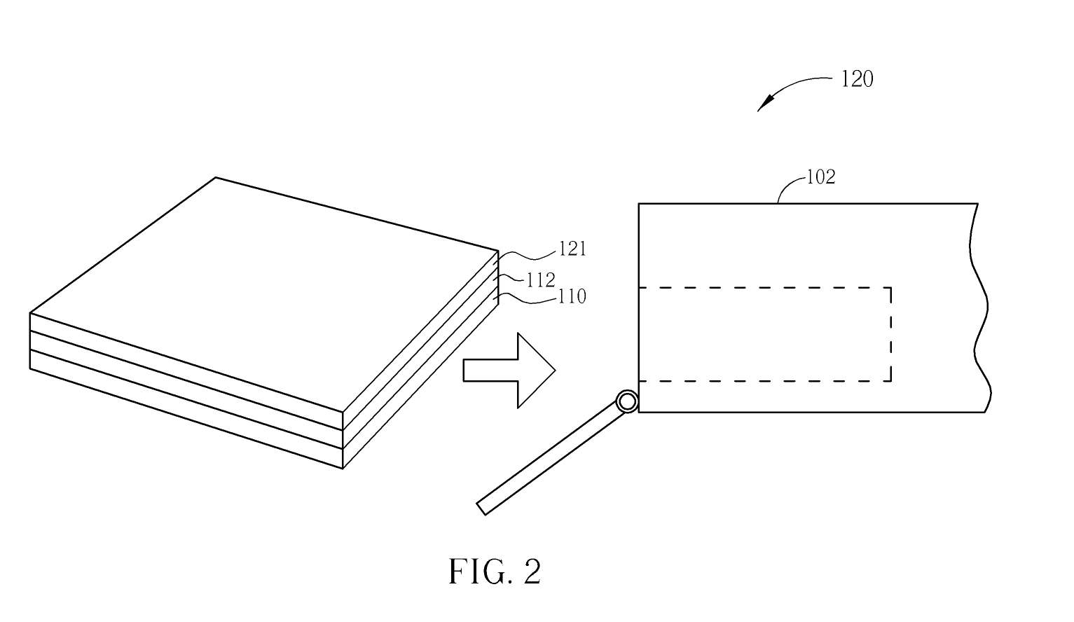

Please refer to FIGS. 2 and 8, which illustrate an illuminating layer printing step 120 is carried out. An illuminating layer 121 is printed on the protection layer 110 in this step 120. The illuminating layer 121 covers the protection layer 110. After the illuminating layer 121 covers the protection layer 110, optionally they may be baked in a baking device 102.

The illuminating layer 121 may include one or more illuminating materials. These may be a fluorescent material or a phosphorescent material, such as a sulfide, an alumina or a rare earth element, etc. The illuminating layer 121 may have a proper thickness, such as 50 μm-100 μm of ZnS, CaS, SrAl₂O₄, CaAl₂O₄, and/or BaAl₂O₄. A better illuminating layer 121 may have a longer illuminating time or a higher illuminating brightness.

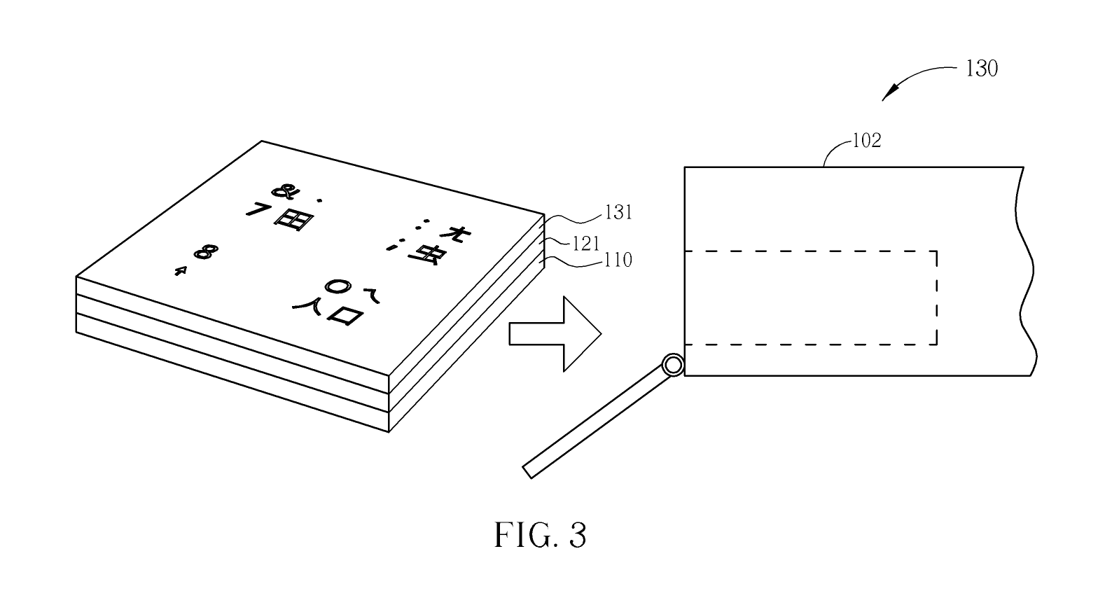

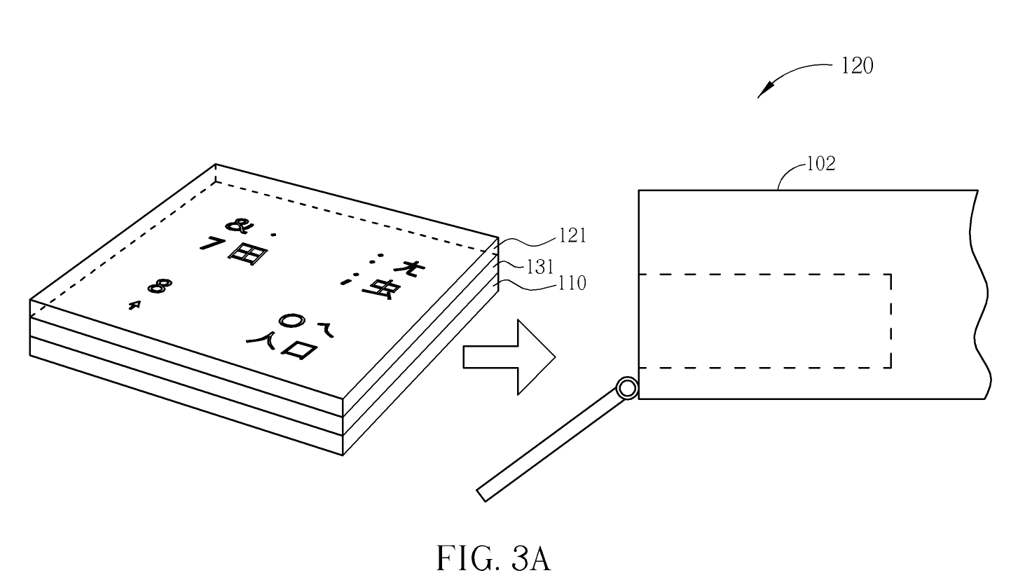

Please refer to FIGS. 3 and 8, which show a symbol layer printing step 130 is carried out to print a symbol layer 131 on the protection layer 110 after the illuminating layer printing step 120. After the symbol layer printing step 130, optionally the symbol layer 131 and protection layer 110 may be baked in a baking device 102.

There may be at least one symbol 132 disposed on the symbol layer 131. The symbols 132 which are disposed on the symbol layer 131 correspond to the key caps to be formed. The symbols 132 on the symbol layer 131 may be a number, such as 1, 2, 3, 4, 5, 6, 7, 8, 9, 0, letters for different languages, such as [symbol] , [symbol] , [symbol] , [symbol] , J, Q, [symbol] , g, w, \hat{r}, Å, [symbol] , ê, ï, ø, œ, ù, Ω, Σ, β, [symbol] , [symbol] , [symbol] , [symbol] , [symbol] , [symbol] , [symbol] , [symbol] , . . . etc, characters for different languages, such as [symbol] , [symbol] , [symbol] , [symbol] . . . etc, or other symbols for writing, such as £, [symbol] , #, *, @, &, !, (, ), +, ̂, _, / . . . etc.

In one embodiment of the present invention, there may be one symbol 132 on the symbol layer 131, or there may be multiple symbols 132 on the symbol layer 131. For example, various numbers, letters, characters, or symbols are disposed together on the symbol layer 131 at the users' disposal. In another embodiment of the present invention, various symbols 132 on the symbol layer 131 may include at least one color or more than one color, such as red, yellow, green, blue and black, to facilitate the users in distinguishing one from another.

In still another embodiment of the present invention, the illuminating layer printing step 120 and the symbol layer printing step 130 in the present invention may have an optional sequence. For example, please refer to FIG. 3. The illuminating layer printing step 120 is carried out before the symbol layer printing step 130, so the symbols 132 on the symbol layer 131 may look brighter. Alternatively, please refer to FIG. 3A, which shows the illuminating layer printing step 120 is carried out after the symbol layer printing step 130, so the symbols 132 on the symbol layer 131 may look clearer. Different embodiments may be practiced in accordance with different situations to meet different demands.

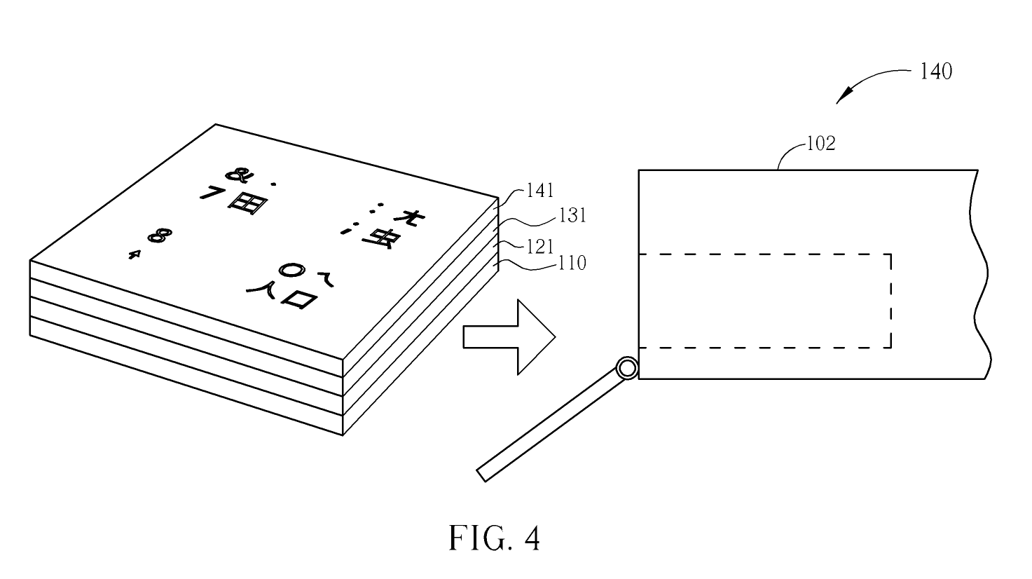

Next, please refer to FIGS. 4 and 8. As shown, a back color layer printing step 140 is carried out after the symbol layer printing step 130 to print a back color layer 141 on the protection layer 110 with the illuminating layer 121 and the symbol layer 131 thereon. After that, optionally, the protection layer 110 with the illuminating layer 121 and the symbol layer 131 may be baked in a baking device 102.

The back color layer 141 serves as a visual contrast basis for the illuminating layer 121 and the symbol layer 131. The back color layer 141 usually includes a plastic material and may be a plastic film with a light color. For example, the color for the back color layer 141 may be white, ivory, milk white, snowy white, oyster white, bluish white, light grey, light blue, light green, light yellow, cream . . . etc.

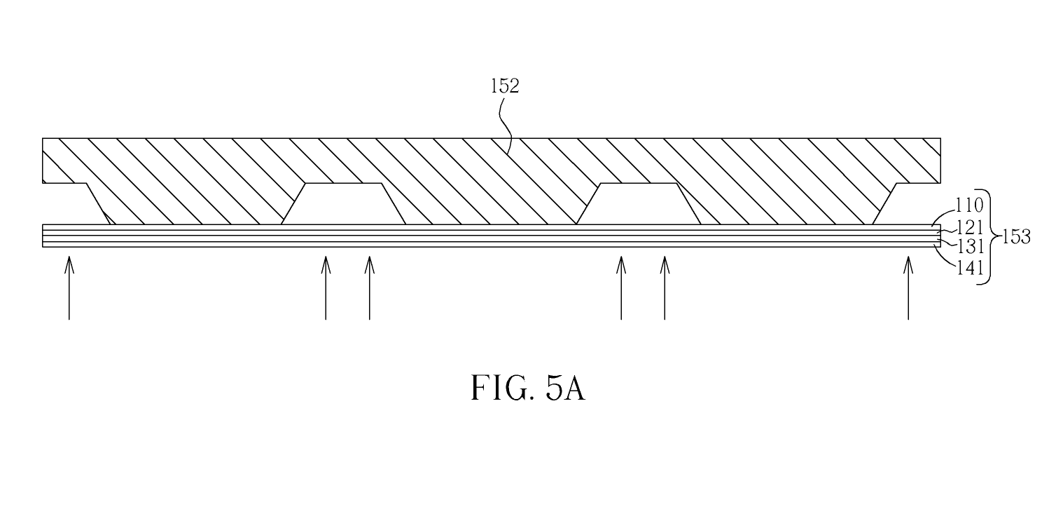

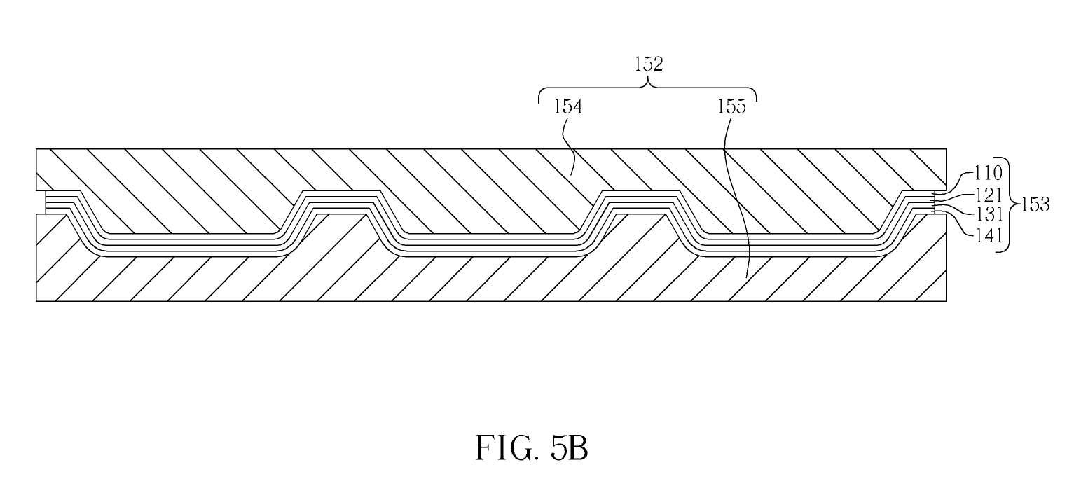

Please refer to FIGS. 5 and 8. As shown, a film thermo-forming step 150 is carried out after the back color layer printing step 140. In this step 150, the protection layer 110 with the illuminating layer 121, the back color layer 141 and the symbol layer 131 together becomes a molded shell-like film 151 after the protection layer 110 with the illuminating layer 121, the back color layer 141 and the symbol layer 131 is placed on a mold and step 150 is completed.

FIGS. 5A and 5B illustrate various processes for the film thermo-forming step 150. A gas blows against (along the direction shown in FIG. 5A) a mold 152 so that the thermo-softened film 153 is pressed against the mold 152 to be shaped like a concavo-convex key caps. Alternatively, a cavity and a core are used to shape the film 153. As shown in FIG. 5B, the mold 152 includes a core 154 and a cavity 155. The film 153 is shaped after the cavity 155 and the core 154 are heated and pressed against each other.

In one embodiment of the present invention, the back color layer 141 may contact the mold 152. The mold 152 is arranged differently in accordance with different designs: for example, the mold 152 is placed under the film 153 and the gas blows downwards. In other words, the mold 152 may contact the film 153 or the back color layer 141 in the film thermo-forming step 150.

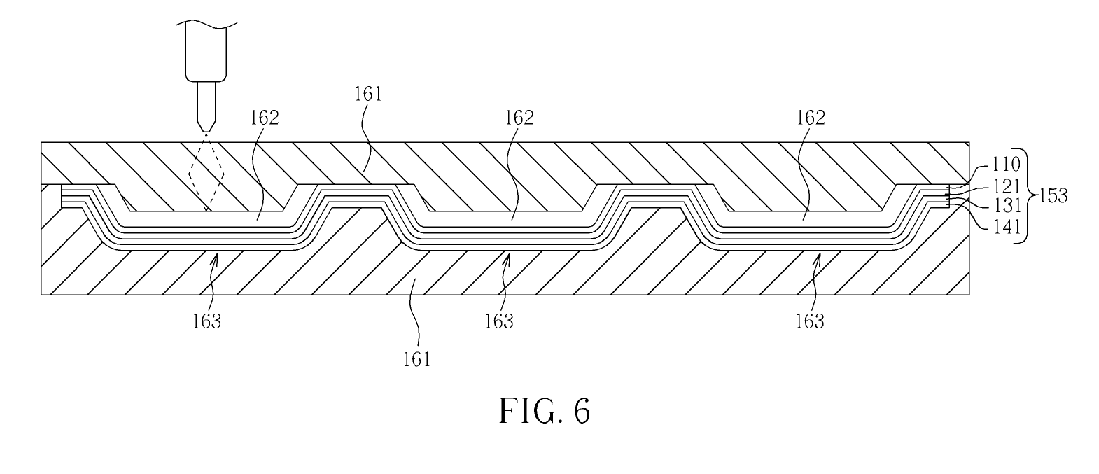

Please refer to FIGS. 6 and 8. As shown, a plastic-injection step 160 is carried out after the film thermo-forming step 150. In this step 150, a filling layer 162 is formed on the back color layer 141 by placing the shell film 151 in a plastic-injection mold 161. The obtained product has a plurality of connecting key caps 163.

As shown in FIG. 6, the shell film 151 is taken from the plastic-injection mold 161 after the plastic-injection step 160. The shell film 151 is then placed on a plastic-injection mold 161 to carry out a plastic-injection step 160 so that the filling layer 162 is formed on the back color layer 141. In addition to forming a shape with respect to the film 153, the filling layer 162 also makes up for the insufficiency of the film 153 in the film thermo-forming step 150. Although the film thermo-forming step 150 may make the film 153 have a certain shape, the plastic-injection step 160 may make up for the adverse change of the film 153, such as the shrinkage due to the elastic force of the material itself, caused by the pressure of the plastic-injection force if the shape changes due to the change in temperature.

The filling layer 162 is a basic supporting element disposed under the illuminating key caps 163. The filling layer 162 is a solid supporting element, and usually includes a filling material. For example, the filling layer 162 includes at least one of a hard plastic and a soft silicone. The hard plastic may be an engineering-plastic and the soft silicone may be a silicone rubber. The size of the filling layer 162 may be adjusted in accordance with different needs. For example, the filling layer 162 may be smaller and flat for use in a mobile device to form a multi-layer stacking input device. In another embodiment, the filling layer 162 may be larger and 3-D for use in a desk-top device. A multi-layer stacking is illustrated.

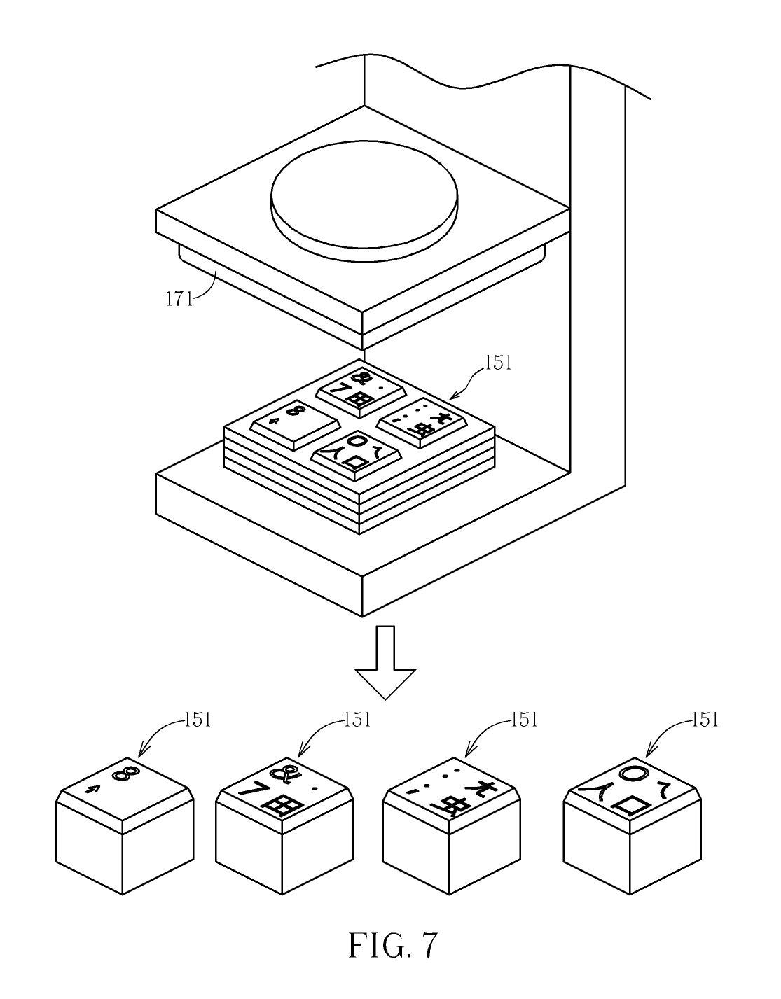

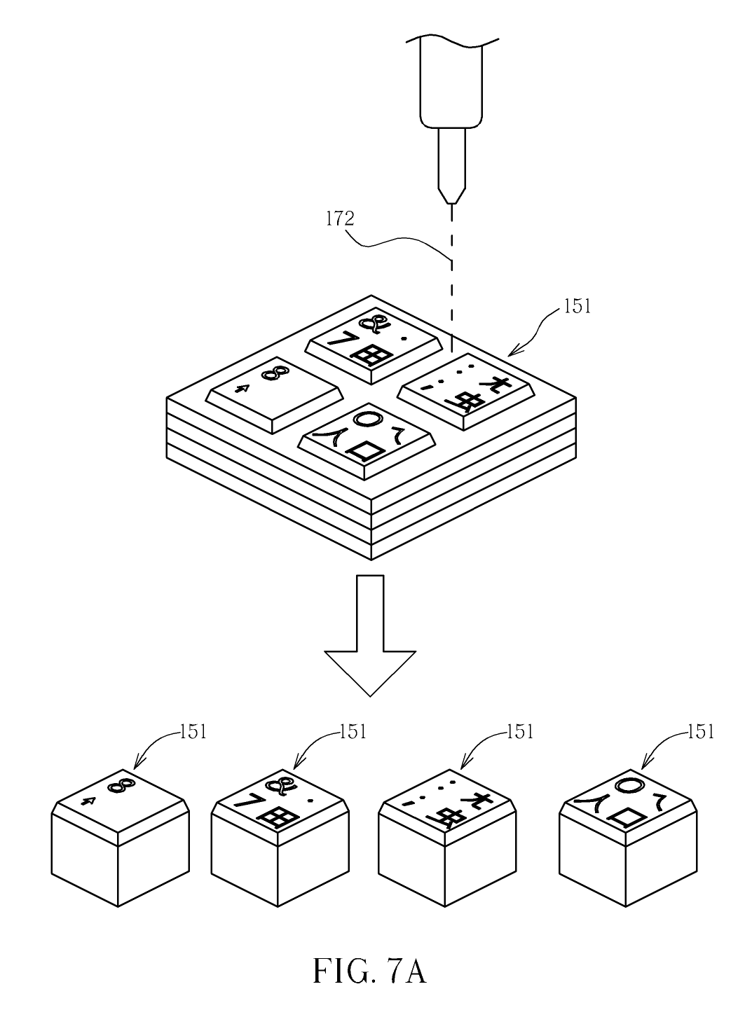

Please refer to FIGS. 7 and 8, which illustrate an optional die cutting step 170 after the plastic-injection step 160. The film 153 with the filling layer 162 is cut to form a plurality of independent key caps 163 after the film 153 with the filling layer 162 is taken from the plastic-injection mold 161.

As shown in FIG. 7, a cutting mold 171 may be used in the die cutting step. Or, as shown in FIG. 7A, laser may be used in the die cutting step to cut where keycaps 163 are connected (the place without the film) to obtain independent key caps 163. As shown in FIGS. 7 and 7A, symbols 132 on the symbol layer 131 are visible to the users because the protection layer 110 is transparent or translucent. Further, symbols 132 on the symbol layer 131 are still visible to the users in the absence of sufficient external light because the illuminating layer 121 provides illumination on the symbol layer 131. As a result, the numbers, letters, characters or symbols in the key caps 163 are still clear to the users in the absence of sufficient external light.

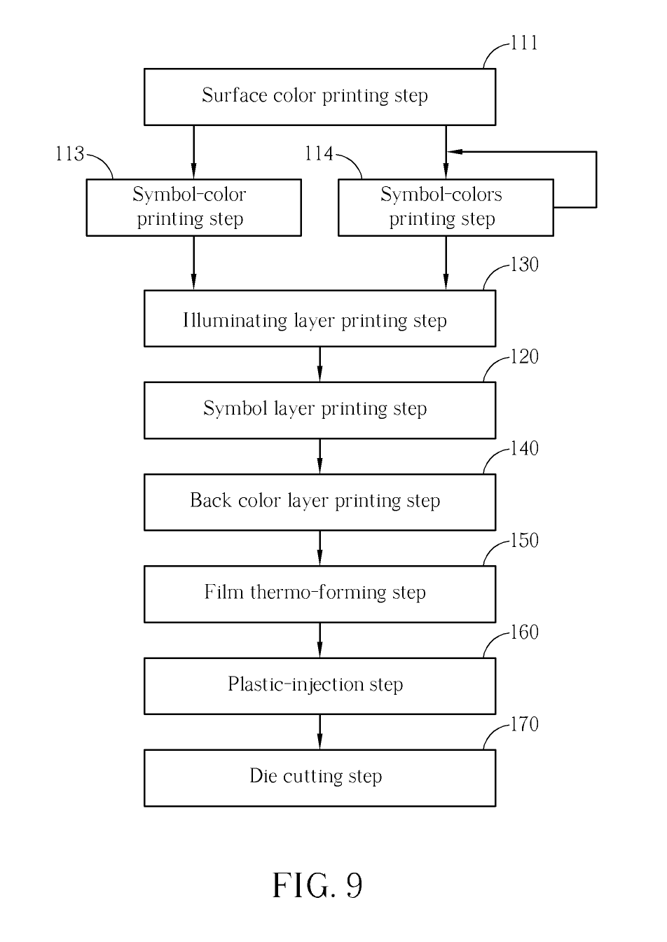

FIG. 8 illustrates a flow chart of the method for making key caps and keyboards of the present invention. FIG. 9 illustrates another flow chart of the method for making key caps and keyboards of the present invention. Optionally, after the surface color layer printing step 111, a symbol-color printing step 113 or a symbol-colors printing step 114 may be carried out. As shown in FIG. 9, symbols 132 may have different colors. The symbol-colors printing step 114 may be carried out more than once to repeatedly print different color layers of a different color on the surface color layer 112 before the layers are baked at least once.

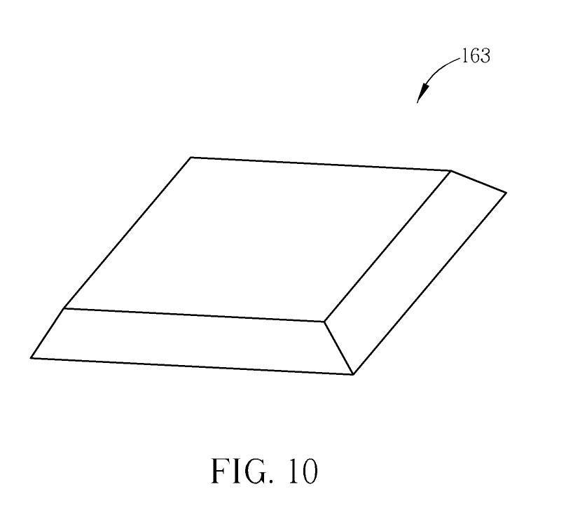

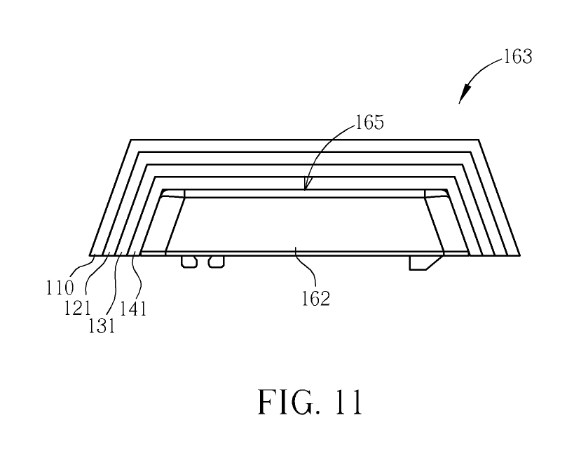

After the above-mentioned steps are performed, an illuminating key cap structure is obtained. FIGS. 10-14 illustrate various embodiments of the illuminating key cap structure of the present invention. FIG. 10 illustrates a perspective view of the illuminating key cap structure of the present invention. Please refer to FIG. 11. The illuminating key cap structure 163 of the present invention includes a filling layer 162, a back color layer 141, a symbol layer 131, an illuminating layer 121 and a protection layer 110. The elements in the illuminating key cap structure 100 of the present invention may have various embodiments in one aspect to facilitate the users in using the illuminating key cap structure 100 and in another aspect for different purposes.

Please refer to FIG. 11. As shown, the filling layer 162 is a basic supporting element disposed under the illuminating key caps 163. The filling layer 162 is a solid supporting element, and usually includes a filling material. For example, the filling layer 162 includes a polymer, such as at least one of a hard plastic and a soft silicone. The hard plastic may be an engineering-plastic and the soft silicone may be a silicone rubber. The size of the filling layer 162 may be adjusted in accordance with different needs. For example, the filling layer 162 may be smaller and flat for use in a mobile device to form a multi-layer stacking input device. In another embodiment, the filling layer 162 may be larger and 3-D for use in a desk-top device. A multi-layer stacking is illustrated for users.

The back color layer 141 covers the top surface 165 of the filling layer 162 and serves as a visual contrast basis of the illuminating layer 121 and the symbol layer 131. Preferably, the back color layer 141 directly covers the top surface 165 of the filling layer 162. The back color layer 141 usually includes a plastic material so it may be a plastic film of a light color. For example, the color for the back color layer 141 may be white, ivory, milk white, snowy white, oyster white, bluish white, light grey, light blue, light green, light yellow, cream . . . etc.

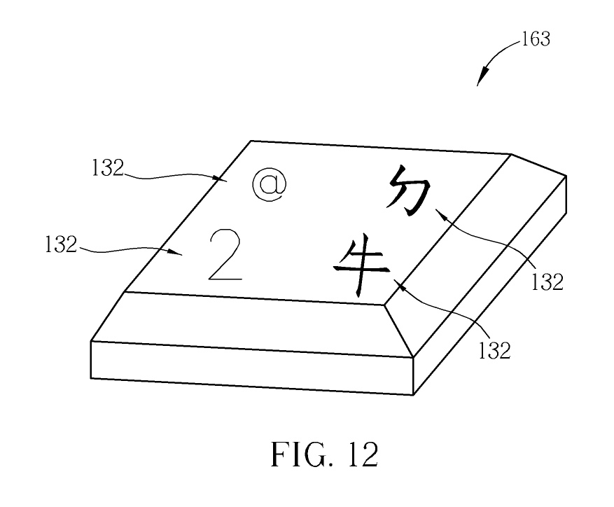

Please refer again to FIG. 11. The symbol layer 131 is disposed on the back color layer 141 and covers the back color layer 141. The symbol layer 131 is disposed on the top surface 165 of the filling layer 162. Please refer to FIG. 12. As shown, there may be at least one symbol 132 disposed on the symbol layer 131. The symbols 132 which are disposed on the symbol layer 131 correspond to the key caps 163. The symbols 132 on the symbol layer 131 may be a number, such as 1, 2, 3, 4, 5, 6, 7, 8, 9, 0, letters of different languages, such as [symbol] , [symbol] , [symbol] , [symbol] , J, Q, [symbol] , g, w, \hat{r}, Å, [symbol] , ê, ï, ø, œ, ù, Ω, Σ, β, π, [symbol] , [symbol] , [symbol] , [symbol] , [symbol] , [symbol] , [symbol] . . . etc, characters of different languages, such as [symbol] , [symbol] , [symbol] , [symbol] . . . etc, or other symbols for writing, such as £, [symbol] , #, *, @, &, !, (, ), +, ̂, _, / . . . etc.

In one embodiment of the present invention, there may be one symbol 132 on one key cap 163, or there may be multiple symbols 132 on one keycap 163. For example, various numbers, letters, characters, or symbols are disposed together on the symbol layer 131 at the users' disposal. In another embodiment of the present invention, various symbols 132 on the symbol layer 131 may include at least one color or more than one color, such as red, yellow, green, blue and black, to facilitate the user in distinguishing one from another.

For the key caps used in computers, one key cap may include multiple letters or symbols. Because the back color layer 141 of the present invention has a lighter contrast color, and various symbols 132 on the symbol layer 131 may have different colors, the present invention may provide vivid letters or symbols of clear contrast owing to the illuminating material and to present multiple colors of clear contrast.

The illuminating layer 121 covers the symbol layer 131 and the back color layer 141, and directly contacts the symbol layer 131. The illuminating layer 121 may include one or more illuminating materials. They may be a fluorescent material or a phosphorescent material, such as a sulfide, an alumina or a rare earth element, etc. The illuminating layer 121 may have a proper thickness, such as 50 μm-100 μm of ZnS, CaS, SrAl₂O₄, CaAl₂O₄, and BaAl₂O₄. A better illuminating layer 121 may have a longer illuminating time or a higher illuminating brightness.

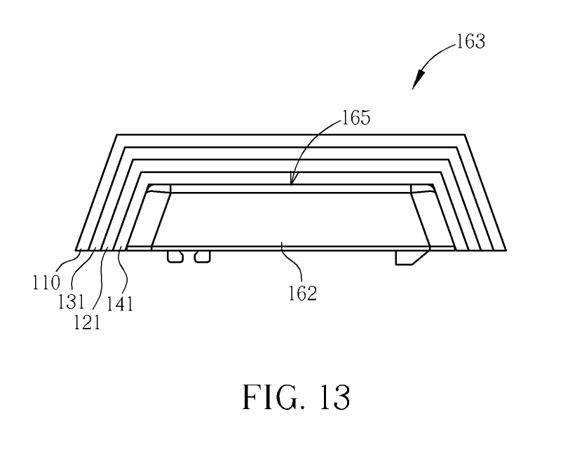

In one embodiment of the present invention as shown in FIG. 13, the illuminating layer and the symbol layer in the present invention may have an optional sequence. For example, the illuminating layer 121 directly covers the symbol layer 131; that is, the illuminating layer 121 is disposed directly above the symbol layer 131 so the symbols 132 on the symbol layer 131 may look brighter. Alternatively, please refer to FIG. 12, which shows the symbol layer 131 directly covering the illuminating layer 121; that is, the symbol layer 131 is disposed directly above the illuminating layer 121, so the symbols 132 on the symbol layer 131 may look clearer. Different embodiments may be practiced in accordance with different situations to meet different demands.

There is a protection layer 110 which is transparent or translucent and covers the symbol layer 131 and the illuminating layer 121 to cover the top surface 165 of the filling layer 162. The protection layer 110 may protect other elements in the key caps 163 from damage, such as dust, vapor, or scratches. The protection layer 110 usually includes a plastic or polymer material, and preferably a transparent or translucent polymer such as at least one of a polycarbonate film and a polyethylene glycol film. For example, the protection layer 110 may have a thickness between 1 mm-0.8 mm.

When the illuminating material in the illuminating layer 121 absorbs a photon from a light source, the electrons in the atoms of the illuminating material jump from the ground state to an excited state. Later, when the electrons in the atoms of the illuminating material return to the ground state, the absorbed energy is released in the form of light. The light is able to illuminate all the symbols 132 disposed on the symbol layer 131 for a long period of time. Therefore, there is no need for an external light source to illuminate all the symbols 132 disposed on the symbol layer 131, which saves energy and is environmentally friendly.

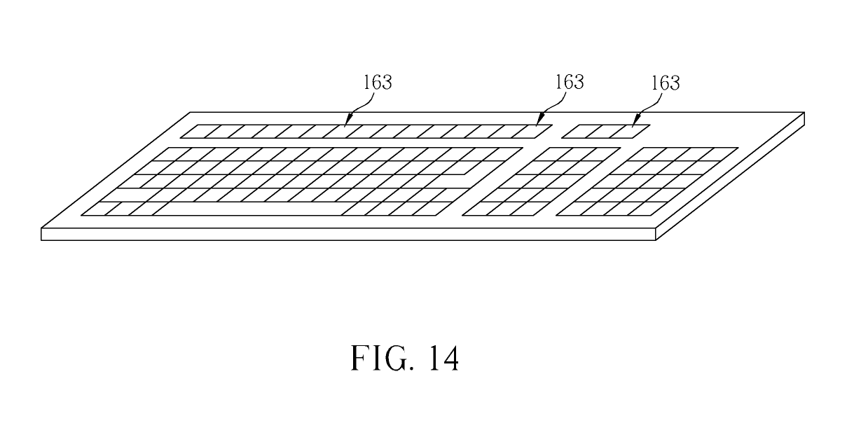

The light source to be absorbed by the illuminating material may be a display, natural light such as sun light, an artificial light such as a light bulb, a built-in light such as an LED or an external light such as a flashlight. Regardless of the type of light source, the illuminating material is able to illuminate all the symbols 132 disposed on the symbol layer 131 for a long period of time once it is activated. The symbols 132 on the symbol layer 131 are still visible to users in the absence of sufficient external light because the illuminating layer 121 provides illumination on the symbol layer 131. As a result, the numbers, letters, characters or symbols in the key caps 163 are still clear. As shown in FIG. 14, the keyboard of the key caps 163 of the present invention may be a flat keyboard.

Those skilled in the art will readily observe that numerous modifications and alterations of the device and method may be made while retaining the teachings of the invention.

What is claimed is:

1. An illuminating key cap structure, comprising:
a filling layer comprising a filling material;
a back color layer covering the top surface of said filling layer;
a symbol layer covering said back color layer;
an illuminating layer comprising an illuminating material and covering said back color layer, wherein said illuminating layer is in direct contact with said symbol layer; and
a protection layer which is translucent and covers the top surface of said filling layer.

2. The illuminating key cap structure of claim 1, wherein said filling layer comprises at least one of a hard plastic and a soft silicone.

3. The illuminating key cap structure of claim 1, wherein said back color layer has a light color to serve as a contrast basis for said symbol layer.

4. The illuminating key cap structure of claim 1, wherein said illuminating layer directly covers said symbol layer.

5. The illuminating key cap structure of claim 1, wherein said symbol layer directly covers said illuminating layer.

6. The illuminating key cap structure of claim 1, wherein said symbol layer comprises at least one color.

7. The illuminating key cap structure of claim 6, wherein said color includes red, yellow, green, blue and black.

8. The illuminating key cap structure of claim 1, wherein said illuminating layer comprises at least one of a sulfide, an alumina, a rare earth element, a fluorescent material and a phosphorescent material.

9. The illuminating key cap structure of claim 1, wherein said illuminating layer comprises at least one of ZnS, CaS, SrAl₂O₄, CaAl₂O₄ and BaAl₂O₄.

10. The illuminating key cap structure of claim 1, wherein said illuminating material has a thickness of 50 μm-100 μm.

11. The illuminating key cap structure of claim 10, wherein said protection layer comprises a transparent polymer.

12. The illuminating key cap structure of claim 11, wherein said transparent polymer includes at least one of a polycarbonate film and a polyethylene glycol film.

13. The illuminating key cap structure of claim 12, wherein said protection layer has a thickness of 1 mm-0.8 mm.

14. A method for making a key cap, comprising:
providing a protection layer which is translucent;
performing an illuminating layer printing step including printing an illuminating layer on said protection layer before baking;
performing a symbol layer printing step including printing a symbol layer on said protection layer before baking;
performing a back color layer printing step including printing a back color layer on said protection layer comprising said illuminating layer and said symbol layer before baking;
performing a film thermo-forming step including placing said protection layer comprising said back color layer, said illuminating layer and said symbol layer in a mold to obtain a shell film; and
performing a plastic-injection step including placing said shell film in a plastic-injection mold to form a filling layer comprising a plurality of connecting key caps on said back color layer.

15. The method for making a key cap of claim 14, further comprising:
performing a die cutting step including cutting said shell film comprising said filling layer to form a plurality of independent key caps.

16. The method for making a key cap of claim 14, further comprising:
before said illuminating layer printing step, performing a surface color layer printing step including printing a surface color layer on said protection layer before baking.

17. The method for making a key cap of claim 14, wherein said filling layer comprises at least one of a hard plastic and a soft silicone.

18. The method for making a key cap of claim 14, wherein said back color layer has a light color to serve as a contrast basis for said symbol layer.

19. The method for making a key cap of claim 14, wherein said illuminating layer printing step is performed after said symbol layer printing step.

20. The method for making a key cap of claim 14, wherein said illuminating layer printing step is performed before said symbol layer printing step.

21. The method for making a key cap of claim 20, wherein said color includes red, yellow, green, blue and black.

22. The method for making a key cap of claim 14, wherein said symbol layer comprises at least one of a character, a number and a symbol.

23. The method for making a key cap of claim 14, wherein said illuminating layer comprises at least one of a sulfide, an alumina, a rare earth element, a fluorescent material and a phosphorescent material.

24. The method for making a key cap of claim 14, wherein said illuminating layer comprises at least one of ZnS, CaS, SrAl₂O₄, CaAl₂O₄ and BaAl₂O₄.

25. The method for making a key cap of claim 14, wherein said illuminating material has a thickness of 50 μm-100 μm.

26. The method for making a key cap of claim 14, wherein said transparent polymer includes at least one of a polycarbonate film and a polyethylene glycol film.

27. The method for making a key cap of claim 14, wherein said protection layer has a thickness of 1 mm-0.8 mm.

28. The method for making a key cap of claim 14, wherein a gas is used in said film thermo-forming step to press against a mold so that said thermo-softened protection layer is pressed against said mold.

29. The method for making a key cap of claim 14, wherein said mold comprises a cavity and a core so that said protection layer is pressed against said mold after said cavity and said core are heated and pressed against each other.

30. The method for making a key cap of claim 15, wherein said die cutting step uses a cutting mold.

31. The method for making a key cap of claim 15, wherein said die cutting step uses a laser.

32. The method for making a key cap of claim 16, further comprising:
after said surface color layer printing step, performing a symbol-color printing step including printing a color layer on said surface color layer before baking.

33. The method for making a key cap of claim 32, further comprising:
performing a symbol-colors printing step including printing another color layer of a different color on said surface color layer before baking.

34. The method for making a key cap of claim 33, further comprising:
repeatedly printing still another color layer of a different color on said surface color layer before baking at least once.
